(19) United States
(12) Patent Application Publication
(10) Pub. No.: US 2006/0212479 A1
(43) Pub. Date: Sep. 21, 2006

(54) System and method for audiovisual display settings

(76) Inventors: Andrew G. Habas, Austin, TX (US); Timothy Abels, Pflugerville, TX (US)

Correspondence Address: HAMILTON & TERRILE, LLP, P.O. BOX 203518, AUSTIN, TX, 78720, US

(21) Appl. No.: 11/085,760

(22) Filed: Mar. 21, 2005

(51) Int. Cl. G06F 17/00

(52) U.S. Cl. 707/104.1

(57) ABSTRACT

Audiovisual settings for audiovisual display devices are automatically applied based on a user identification input at the audiovisual display device. A display settings module associated with the audiovisual device applies locally cached settings if available or retrieves global settings for the user from a network location. A settings match engine determines audiovisual setting for the user based on the audiovisual device type characteristics and the user's globally stored audiovisual settings. Automatically managed audiovisual settings include display picture settings, channel settings, localization settings, audio settings and lockout settings.

### BACKGROUND OF THE INVENTION

1. Field of the Invention

The present invention relates in general to the field of information handling system displays, and more particularly to a system and method for audiovisual display settings.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Much of the popularity of information handling systems has grown from the flexibility provided by the variety of hardware and software components used to build the systems. Indeed, information handling systems are often built-to-order with software and hardware configurations selected by the consumer before the system is built. To further adapt to individual users, operational information handling systems are typically configured to accept and apply personalized settings for interfacing with individual users, such as with software or firmware settings. Users will generally save settings on an information handling system to automatically configure the information handling system on startup without the need for user intervention. For instance, users often configure display settings to present a desired desktop appearance and sound. Unfortunately the ability to select a wide variety of settings often leads to confusion by users regarding which settings to change and how to change the settings. For instance, information handling system displays has different types of settings, different types of menu interfaces and widely varying degrees of complexity that have the effect of discouraging users from using the settings. Even when users do select desired settings, these are often disrupted by power interruption or other users who adjust the settings.

Recently, an increasing convergence has come about between information handling system displays and television displays. In part this convergence has resulted from the introduction of high definition televisions, which use technology that is similar to that of information handling system displays, such as LCD, plasma and projection technology. Televisions have migrated from dumb analog devices to intelligent digital devices that communicate information over networks, such as to allow users to select entertainment. Although the quality and flexibility of information presentation at televisions has steadily improved, the complexity of user interactions with the television displays has also increased. Users need to be increasingly tech-savvy to perform basic setting adjustments, such as brightness, contrast, tint and content presets and often must immerse themselves in users' manuals to select other adjustments, such as channel settings, audio settings, localization settings, lockout settings. This complexity tends to discourage users from applying individual settings at a device. Those that do apply individual settings typically must do so frequently since the settings are commonly lost at power outages or when changed by another user.

### SUMMARY OF THE INVENTION

Therefore a need has arisen for a system and method which manages display configuration settings for plural users across plural displays.

In accordance with the present invention, a system and method are provided which substantially reduce the disadvantages and problems associated with previous methods and systems for managing display configuration settings. Individual user display settings are tracked by a user identification for automated application to a display device with input of the user identification at the display device.

More specifically, an audiovisual server information handling system receives requests for audiovisual settings from audiovisual display devices, such as televisions or information handling system displays. The audiovisual server looks up the audiovisual settings from a global user identification database by reference to a user identification input through the display device. If the settings are for an audiovisual display device of a different type than the current device, a settings match engine converts the stored audiovisual settings into settings for the current device by reference to a global identifier device database that stores audiovisual device characteristics. User identifications and associated audiovisual settings are optionally cached locally to the display device for availability without having to contact the audiovisual server.

The present invention provides a number of important technical advantages. One example of an important technical advantage is that a user is able to select audiovisual options once for repeated application at a variety of audiovisual devices with selected options applied as a best fit across different types of display devices. A user's audiovisual selections are automatically applied on input of a user identification or other interaction by the user with a display device that identifies the user. Audiovisual devices support plural settings so that a user need not repeatedly reset preferences after someone else uses the device and alters the settings.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for global management of audiovisual display settings; and

FIG. 2 depicts a flow diagram of a process for global management of audiovisual display settings.

### DETAILED DESCRIPTION

Audiovisual displays automatically apply audiovisual settings for a user identification by reference to a global audiovisual settings database available from an audiovisual information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

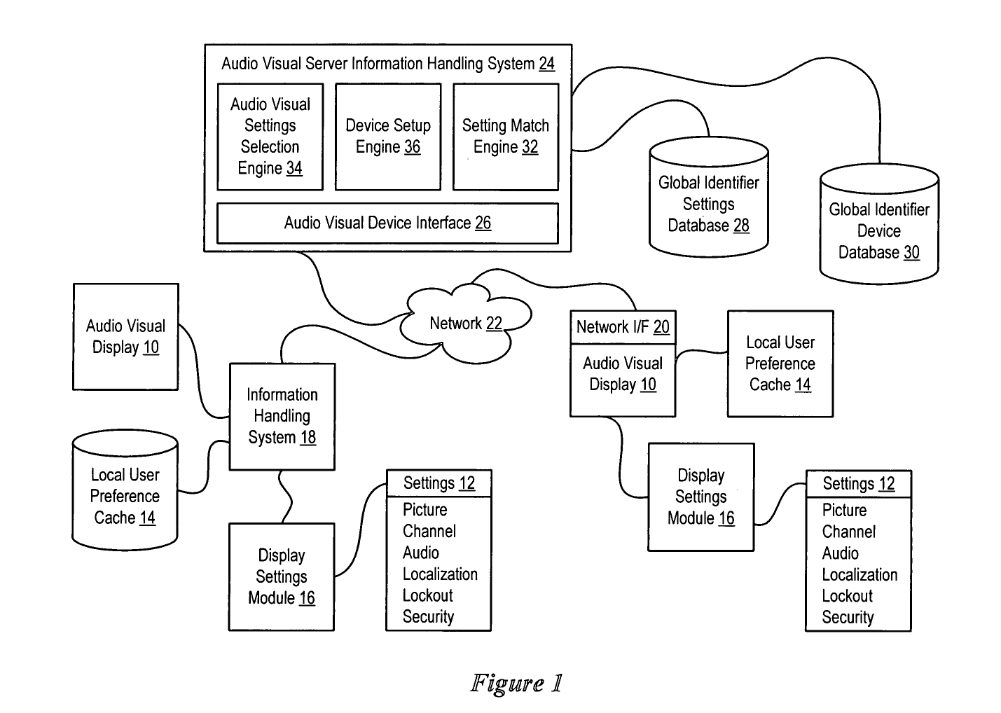

Referring now to FIG. 1, a block diagram depicts a system for global management of audiovisual display settings. Audiovisual displays 10 are televisions or information handling system displays that present audiovisual information to a user by applying audiovisual settings 12. Audiovisual picture settings determine the brightness, contrast, tint, and related visual characteristics of a display 10, as well as other picture options such as aspect ratio settings, like 4:3 or 16:9. Audiovisual channel settings determine the content associated with selection of a channel at the device, such as by mapping television stations to a channel number or favorite user station or stations. In addition, other channel viewing options may be included, such as PIP, POP and PBP modes. Audio settings determine the characteristics of the audio output from speakers, such as the equalizer settings, surround sound effects and secondary audio programming. Localization settings determine the language of text On Screen Display (OSD), closed caption or teletext modes. Lockout settings determine parental control and limited channel availability, such with public displays that have a single channel as a kiosk or limited rights to channels allowed. Security settings encrypt or otherwise restrict access based on user authorization. A local user preference cache stores audiovisual settings by association with user identifications. When a user enters his or her user identification, a display settings module 16 retrieves the audiovisual settings associated with the user from local user preference cache 14 and automatically applies the audiovisual settings to audiovisual display device 10. Display settings module 16 is, for instance, a module running on firmware of display 10 or on an information handling system 18 interfaced with display 10.

If a user identification is entered at an audiovisual display 10 that is not found in local user preference cache 14, then a network interface 20 associated with the audiovisual display 10 retrieves audiovisual settings for application at display 10 through a network 22 and audiovisual server information handling system 24. An audiovisual device interface 26 receives the user identification from the audiovisual display 10 and retrieves the audiovisual settings associated with the user identification from a global identifier settings database 28. If the user's audiovisual settings are for a device that do not match the type of device currently requesting the settings, a settings match engine determines appropriate settings for the current device based on information retrieved from a global identifier device database 30. Settings match engine 32 translates the user settings stored in settings database 28 from settings appropriate for an original device to settings appropriate for a current device by comparing the device characteristics stored in device database 30. For instance, if a user's audiovisual settings define channel settings for Austin, Tex., but the current audiovisual display is located in Dallas, Tex., settings match engine 32 maps the Dallas channels to the Austin channel setting so that the user is able to select channels based on his familiar Austin channel settings. As another example a parent who sets parental control for a child will have those parent controls enforced wherever the child inputs the child's user identification.

Audiovisual settings for user identifications are managed by an audiovisual settings selection engine 34 in a variety of ways. For instance, when a user first inputs audiovisual settings at an audiovisual display 10, audiovisual settings engine detects the settings and device type for storage in identifier settings database 28. As another example, a user who purchases an audiovisual display device is provided with an opportunity to input settings at the purchase, such as in a build-to-order system. Audiovisual settings selection engine 34 stores the settings in database 28 so that the user has the settings available on the initial use of the display. Alternatively, audiovisual settings selection engine 34 interfaces with the device at manufacture to have the audiovisual settings stored in local 14 at manufacture. A device setup engine 36 allows manufacturers to add support for audiovisual display devices by type as the devices are designed. Device setup engine 36 accepts audiovisual characteristics of devices by type to map the characteristics to other device types and stores the characteristics information in device database 30. Settings match engine 32 references the device characteristics in device database 30 in the event that the type of device currently used by the user does not match the type of device associated with the user in settings database 28.

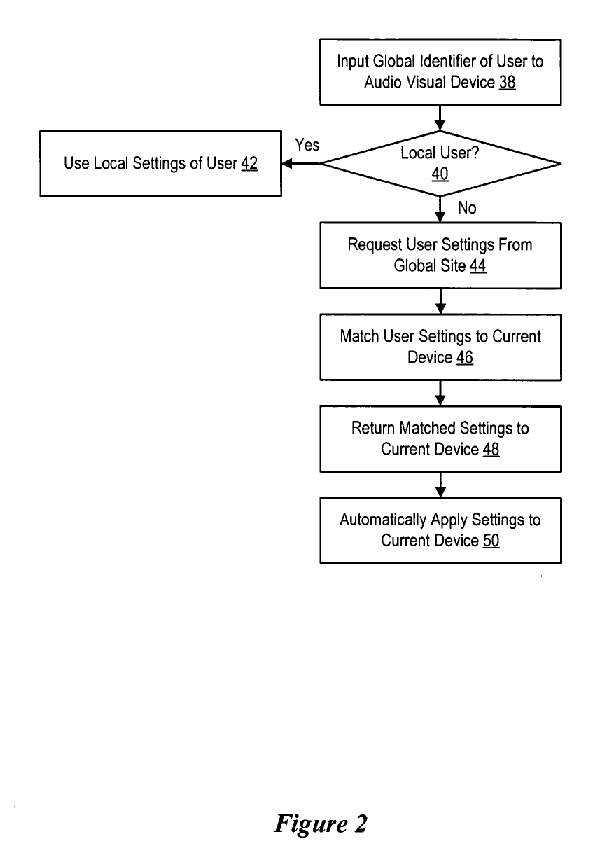

Referring now to FIG. 2, a flow diagram depicts a process for global management of audiovisual display settings. The process begins at step 38 with the input of a global identifier of a user to an audiovisual device. At step 40 a determination is made of whether the user is a local user and, if so, at step 42 the local settings of the user are applied to the audiovisual device. If the user is not a local user, the process continues to step 44 for the audiovisual device to request the user settings associated with the user identifier from a global site. At step 46, the user settings associated with the user identification are matched to the audiovisual device requesting the settings. At step 48, the matched settings are returned to the current requesting audiovisual device so that at step 50 the settings are automatically applied to the current device to display information.

Although the present invention has been described in detail, it should be understood that various changes, substitutions and alterations can be made hereto without departing from the spirit and scope of the invention as defined by the appended claims.

What is claimed is:

1. An information handling system comprising:
an audiovisual device interface operable to communicate with audiovisual devices through a network to retrieve a user identifier and device identifier from an audiovisual device;
a user identifier settings database having plural users, each user associated with an identifier and one or more audiovisual settings;
a device database having plural devices, each device associated with audiovisual characteristics; and
an audiovisual settings match engine operable to match the user audiovisual settings to the device audiovisual characteristics to determine device audiovisual settings for application at the device when in use by the user.

2. The information handling system of claim 1 further comprising:
an audiovisual settings selection engine operable to receive settings from a user and store the settings in the user identifier settings database; and
a device setup engine operable to receive and store device audiovisual characteristics.

3. The information handling system of claim 1 wherein the audiovisual settings comprise display picture settings.

4. The information handling system of claim 1 wherein the audiovisual settings comprise channel settings.

5. The information handling system of claim 1 wherein the audiovisual settings comprise localization settings.

6. The information handling system of claim 1 wherein the audiovisual settings comprise audio settings for operating speakers.

7. The information handling system of claim 1 wherein the audiovisual settings comprise lockout settings.

8. A method for determining audiovisual display settings, the method comprising:
inputting a user identification to an audiovisual device;
looking up the user identification in a table having plural user identifications, each of the plural user identifications having associated audiovisual settings;
retrieving the audiovisual settings to the audiovisual device; and
applying the audiovisual settings to the audiovisual device to display information.

9. The method of claim 8 wherein looking up the user identification further comprises:
looking up the user identification in local storage associated with the audiovisual device;
determining that the user identification is not is local storage; and
looking up the user identification in global storage through a network.

10. The method of claim 9 further comprising:
determining that the audiovisual settings associated with the user identification in the global storage are audiovisual settings for a different type of audiovisual device;
matching the audiovisual characteristics of the different types of audiovisual devices to determine audiovisual settings for the current audiovisual device; and
applying the matched audiovisual settings to the current audiovisual device.

11. The method of claim 10 wherein the audiovisual settings comprise display picture settings.

12. The method of claim 10 wherein the audiovisual settings comprise channel settings.

13. The method of claim 10 wherein the audiovisual settings comprise localization settings.

14. The method of claim 10 wherein the audiovisual settings comprise audio settings for operating speakers.

15. The method of claim 10 wherein the audiovisual settings comprise lockout settings.

16. An audiovisual device comprising:
a display operable to present information;
a network interface operable to communicate with a network;
a local user preference cache storing plural user identifiers, each user identifier having associated audiovisual settings; and
a display settings module operable to accept a user identification and look up audiovisual settings associated with the user identification from either the local user preference cache or the network, the display settings module automatically applying the audiovisual settings at the audiovisual device.

17. The audiovisual device of claim 16 wherein the audiovisual settings comprise display picture settings.

18. The audiovisual device of claim 16 wherein the audiovisual settings comprise channel settings.

19. The audiovisual device of claim 16 wherein the audiovisual settings comprise localization settings.

20. The audiovisual device of claim 16 wherein the audiovisual settings comprise lockout settings.
